(19) United States
(12) Patent Application Publication
(10) Pub. No.: US 2001/0037222 A1
(43) Pub. Date: Nov. 1, 2001

(54) System and method for assessment of multidimensional pain

(76) Inventors: Allan F. Platt, Lilburn, GA (US); James R. Eckman, Decatur, GA (US); Robert Searfoss, Atlanta, GA (US); Jeffrey M. Dunbar, Lawrenceville, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/852,202

(22) Filed: May 9, 2001

Related U.S. Application Data
(63) Continuation of application No. 09/644,408, filed on Aug. 23, 2000.
(60) Provisional application No. 60/203,024, filed on May 9, 2000.

(51) Int. Cl. G06F 17/60

(52) U.S. Cl. 705/3

(57) ABSTRACT

A system and method providing accurate, quantifiable and reproducible pain assessment documentation utilized in pain management. In particular, the pain assessment system can be implemented as follows. A description input mechanism prompts the collection of patient pain episode data, and a pain assessment mechanism assesses the pain episode data for the patient. A pain score generation mechanism then generates a multidimensional pain score from the pain episode data to quantify a pain condition for the patient. The method can be broadly summarized by the following steps, acquiring pain episode data for the patient; performing pain assessment for the patient; and generating a multidimensional pain score that quantifies a pain condition for the patient.

### CROSS REFERENCE TO RELATED APPLICATIONS

This application is a continuation-in-part of application entitled “System And Method For Assessment Of Multidimensional Pain,” Ser. No. 09/644,408, filed Aug. 23, 2000, and this application also claims the benefit of U.S. Provisional patent application Ser. No. 60/203,024 filed on May 9, 2000, entitled “VitalSigns.MD Installation Instructions”; all of the foregoing of which are now pending and are incorporated herein by reference.

### BACKGROUND OF THE INVENTION

1. Field of the Invention

The present invention generally relates to computers and computer type devices, and, more particularly, to a system and method for providing documentation of accurate, quantitative and reproducible pain assessment.

2. Description of Related Art

Rapid, reproducible and quantifiable multidimensional pain assessment is needed in all hospitals, clinics, and by caregivers that have patients requiring pain management. The result of the pain assessment data over time must be quickly documented in the patient notes. This documentation includes post-op surgical services, ICUs, postpartum obstetric unit, trauma units, oncology units, emergency rooms, and the like.

Currently, systems and methods for pain assessment and documentation are sporadic and there are no standardized methods of capturing pain levels from the patients. All patients undergoing treatment for pain need some sort of pain assessment, related therapy and outcome documentation. This pain assessment documentation should include, for example, but not limited to, data in regard to pain intensity, location, type, radiation, mood, treatment and treatment, side effects; and data in regard to vital signs, and the like.

Thus, a heretofore unaddressed need exists in the industry to address the aforementioned deficiencies and inadequacies.

### SUMMARY OF THE INVENTION

The present invention is generally directed to a pain assessment system and method to provide accurate, quantifiable and reproducible pain assessment documentation utilized in pain management. Briefly described, in architecture, the pain assessment system can be implemented as follows. A description input mechanism prompts the collection of patient pain episode data, and a pain assessment mechanism assesses the pain episode data for the patient. A pain score generation mechanism then generates a multidimensional pain score from the pain episode data to quantify a pain condition for the patient.

The present invention can also be viewed as providing a method that provides for accurate, quantifiable and reproducible pain assessment documentation for pain management. In this regard, the method can be broadly summarized by the following steps: (1) acquiring a pain data for a patient; (2) performing pain assessment for the patient; and (3) generating a multidimensional pain score that quantifies a pain condition for the patient.

Other features and advantages of the present invention will become apparent to one with skill in the art upon examination of the following drawings and detailed description. It is intended that all such additional features and advantages be included herein within the scope of the present invention.

### BRIEF DESCRIPTION OF THE DRAWINGS

The accompanying drawings incorporated in and forming a part of the specification illustrate several aspects of the present invention, and together with the description, serve to explain the principles of the invention. In the drawings:

FIG. 1 is a block diagram of possible devices for the pain assessment system of the present invention.

FIG. 2 is a block diagram illustrating the pain assessment system of the present invention, situated within a computer readable medium, for example, in a user computer system as depicted in FIG. 1.

FIG. 3 is an exemplary flow chart illustrating the architecture and functionality of the pain assessment system for the computer system shown in FIG. 2.

FIG. 4A is an exemplary flow chart illustrating the architecture and functionality of the select patient data process within the pain assessment system shown in FIGS. 2 and 3.

Illustrated in FIG. 4B is an exemplary flow chart illustrating the architecture and functionality of the collect pain statistics process for the collect patient data process in the pain assessment system as shown in FIGS. 2, 3 and 4A.

FIG. 5A is an exemplary flow chart illustrating the architecture and functionality of the compute multi-dimensional pain score process within the pain assessment system shown in FIG. 2 and 3.

FIG. 5B is an exemplary flow chart illustrating the multi-dimensional pain score routine within the pain assessment system, as shown in FIGS. 2, 3 and 5A.

FIG. 6 is an exemplary flow chart illustrating the transmit data to server process of the pain assessment system, as shown in FIGS. 2 and 3.

FIG. 7 is an exemplary flow chart illustrating the multidimensional pain server for a server illustrated in FIG. 1.

### DETAILED DESCRIPTION OF THE PREFERRED EMBODIMENT

The present invention will now be described in detail with specific reference to the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

The invention described herein is an accurate, quantifiable and reproducible pain assessment system used to quantify patient pain. The pain assessment system enables a user to measure pain intensity, pain relief, mood and/or side effects of treatments for pain. The pain assessment system provides a rapidly reproducible and quantifiable multidimensional pain assessment that is needed in all hospitals having patients that require pain management. The results of the pain assessment system, over time, can quickly be documented in patient notes, and over time help identify successful treatments for pain.

The pain assessment system of the present invention may be used to monitor the patient throughout the pain episode, including, pain intensity, pain relief, mood and/or any side effects of pain management therapy. The pain assessment system of the present invention can also be used to document the effect of pain therapy for individual and groups of patients. Some advantages of preferred embodiments of the pain assessment system of the present invention are as follows.

The pain assessment system of the present invention allows a caregiver and patient to establish levels defined as thresholds for further action within pain management. Such element thresholds and/or ranges of thresholds established by the caregiver or patient can be done for each individual or group. The pain assessment system of the present invention also allows the caregiver or patient to automatically calculate or define the priority of each threshold point set.

Furthermore, the pain assessment system can provide automatic alerts to physicians and other caregivers when predetermined pain thresholds are reached or exceeded. These automatic alerts provide notice to the physician and/or caregiver of the current condition of the pain episode and suggest other possible treatments for the management of patient pain.

The pain assessment system of the present invention also provides the ability for physician, caregiver, or other agents to acquire reports with regard to the success of pain management with regard to particular treatments. With this information, the pain assessment system of the present invention allows the physician, caregiver, or other agent to create treatments for the management of pain for a particular patient or group of patients.

The reports utilizing the data created by the pain assessment system of the present invention allow a physician or caregiver to evaluate treatment effectiveness for pain episodes for various prognoses. This is accomplished by analyzing the success/failure of a treatment for large groups.

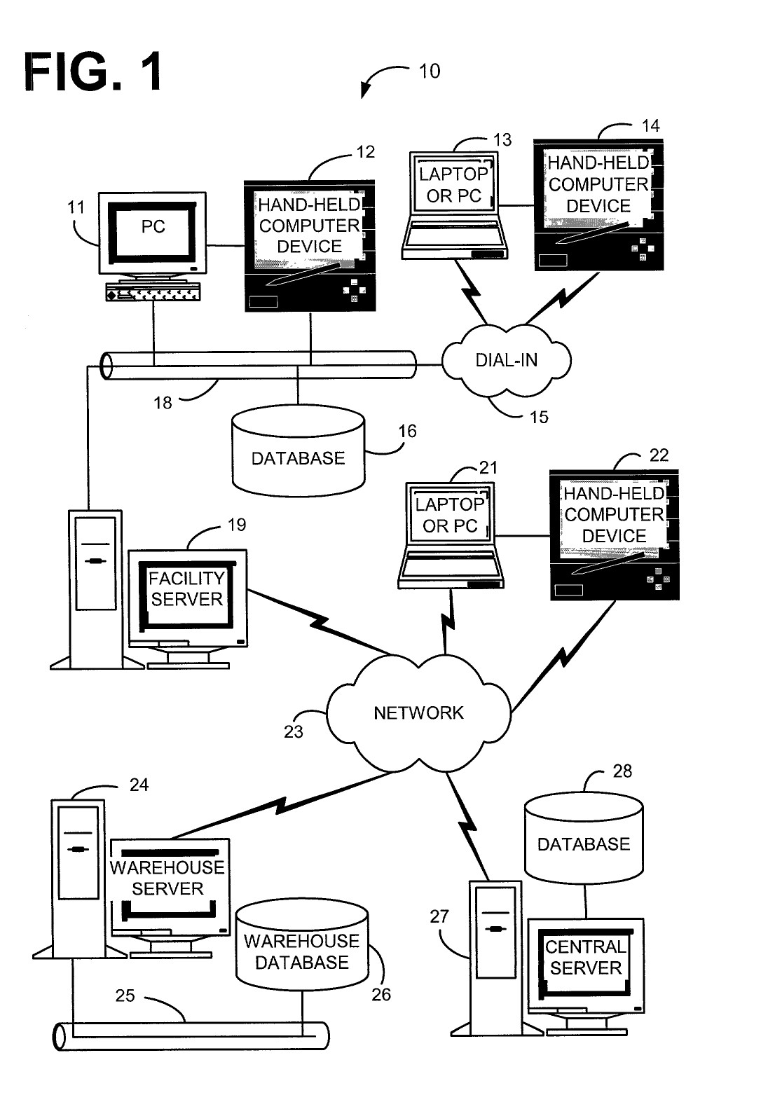

Turning now to the drawings, FIG. 1 is a block diagram of possible system configurations that illustrate the flexibility and platform independence of the present invention. While the pain assessment system configurations could take many forms, the diagram of FIG. 1 illustrates a plurality of devices 11-14 that are directly connected to a network 18, for example, but not limited to, a dial-in, LAN, WAN, PSTN, Intranet and/or Internet communication links.

Each of the devices in FIG. 1 are uniquely illustrated to emphasize that the pain assessment system may exist in diverse hardware configurations and platforms. These devices include, but are not limited to, handheld computer devices, such as, but not limited to, palmtops, cell phones, or the like. These devices also include, but are not limited to laptops, PCs, and any other type of computing device.

As can be seen from FIG. 1, computer device 12 may be connected to PC 11, database 16 and facility server 19 using the network 18. Computer device 12 may also be connected directly to PC 11 by a communications link or port. Some pain assessment systems may exist on some remote devices, such as laptop/PC 13 or 21, or by handheld computer devices 14 or 22 that are connected to the facility server 19 through network 23. Handheld computer device 14 or 22 may also be connected directly to laptop 13 or 21 respectively, by a communications link or port. Network 23 may be comprised of a telephone network, LAN, WAN, intranet or internet network. Network 18 may be, for example, an Ethernet type network (e.g., 10 BASE 2, 10 BASE 5, 10 BSAF, 10 BASE-T, base band network, a coaxial cable, a dial-in, LAN, WAN, PSTN, Intranet and/or Internet.).

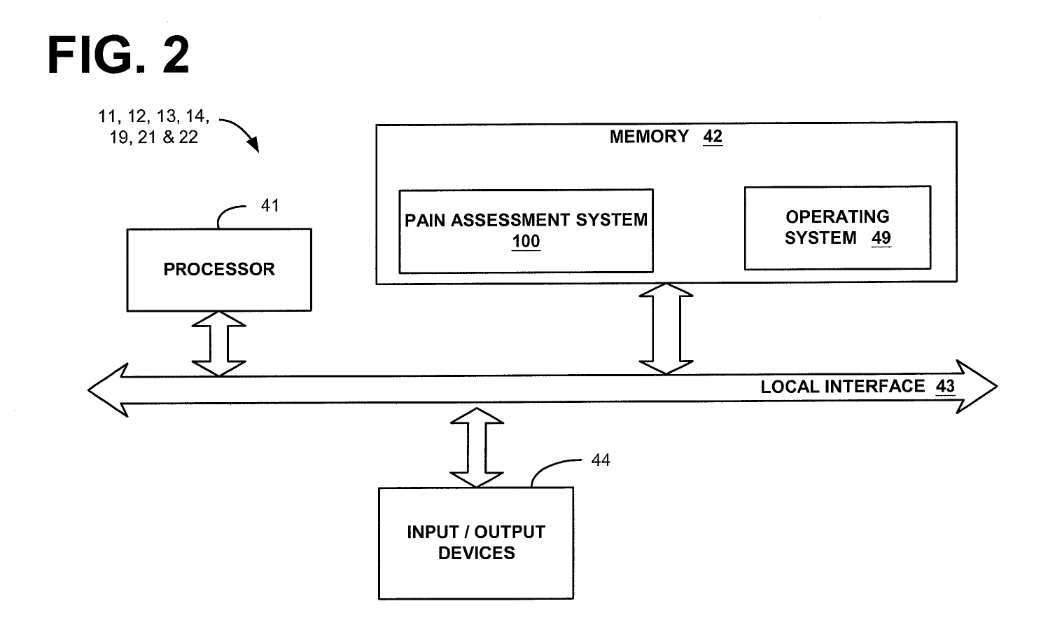

Illustrated in FIG. 2 is a computer system 11, 12, 13, 14, 19, 21 or 22 that can employ a pain assessment system 100 of the present invention. The pain assessment system 100 of the invention can be implemented in software (e.g., firmware), hardware, or a combination thereof. In the currently contemplated best mode, the Pain assessment system 100 is implemented in software, as an executable program, and is executed by a special or general purpose digital computer, such as a personal computer (PC; IBM-compatible, Apple-compatible, or otherwise), workstation, minicomputer, or mainframe computer. An example of a general purpose computer that can implement the Pain assessment system 100 of the present invention is shown in FIG. 2. In FIG. 2, the Pain assessment system 100 is denoted by reference numeral 100.

Generally, in terms of hardware architecture, as shown in FIG. 2, the computer 11-14, 19, 21 or 22 includes a processor 41, memory 42, and one or more input and/or output (I/O) devices 44 (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 41 is a hardware device for executing software that can be stored in memory 42. The processor 41 can be any custom made or commercially available processor, a central processing unit (CPU), an auxiliary processor among several processors associated with the computer 11-14, 19, 21 or 22, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68××× series microprocessor from Motorola Corporation.

The memory 42 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example of FIG. 2, the software in the memory 42 includes the Pain assessment system 100 and a suitable operating system (O/S) 49. A nonexhaustive list of examples of suitable commercially available operating systems 49 is as follows: a Linux operating system, a Windows operating system from Microsoft Corporation, a Netware operating system available from Novell, Inc., or a UNIX operating system, which is available for purchase from many vendors, such as Hewlett-Packard Company, Sun Microsystems, Inc., and AT&T Corporation. The operating system 49 essentially controls the execution of other computer programs, such as the Pain assessment system 100, and provides scheduling, input-output control, file and data management, memory management, and communication control and related services.

The Pain assessment system 100 is a source program, executable program (object code), script, or any other entity comprising a set of instructions to be performed. When a source program, then the program needs to be translated via a compiler, assembler, interpreter, or the like, which may or may not be included within the memory 42, so as to operate properly in connection with the O/S 49. Furthermore, the Pain assessment system 100 can be written as (a) an object oriented programming language, which has classes of data and methods, or (b) a procedure programming language, which has routines, subroutines, and/or functions, for example but not limited to, C, C++, Pascal, Basic, Visual Basic, Fortran, Cobol, Perl, Java, and Ada.

The I/O devices 44 may include input devices, for example but not limited to, a keyboard, mouse, scanner, microphone, etc. Furthermore, the I/O devices 44 may also include output devices, for example but not limited to, a printer, display, etc. Finally, the I/O devices 44 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 11-14, 19, 21 or 22 is a PC, workstation, or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in ROM so that the BIOS can be executed when the computer 11-14, 19, 21 or 22 is activated.

When the computer 11-14, 19, 21 or 22 is in operation, the processor 41 is configured to execute software stored within the memory 42, to communicate data to and from the memory 42, and to generally control operations of the computer 11-14, 19, 21 or 22 pursuant to the software. The Pain assessment system 100 and the O/S 49, in whole or in part, but typically the latter, are read by the processor 41, perhaps buffered within the processor 41, and then executed.

When the Pain assessment system 100 is implemented in software, as is shown in FIG. 2, it should be noted that the Pain assessment system 100 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The Pain assessment system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the pain assessment system 100 is implemented in hardware, the Pain assessment system 100 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

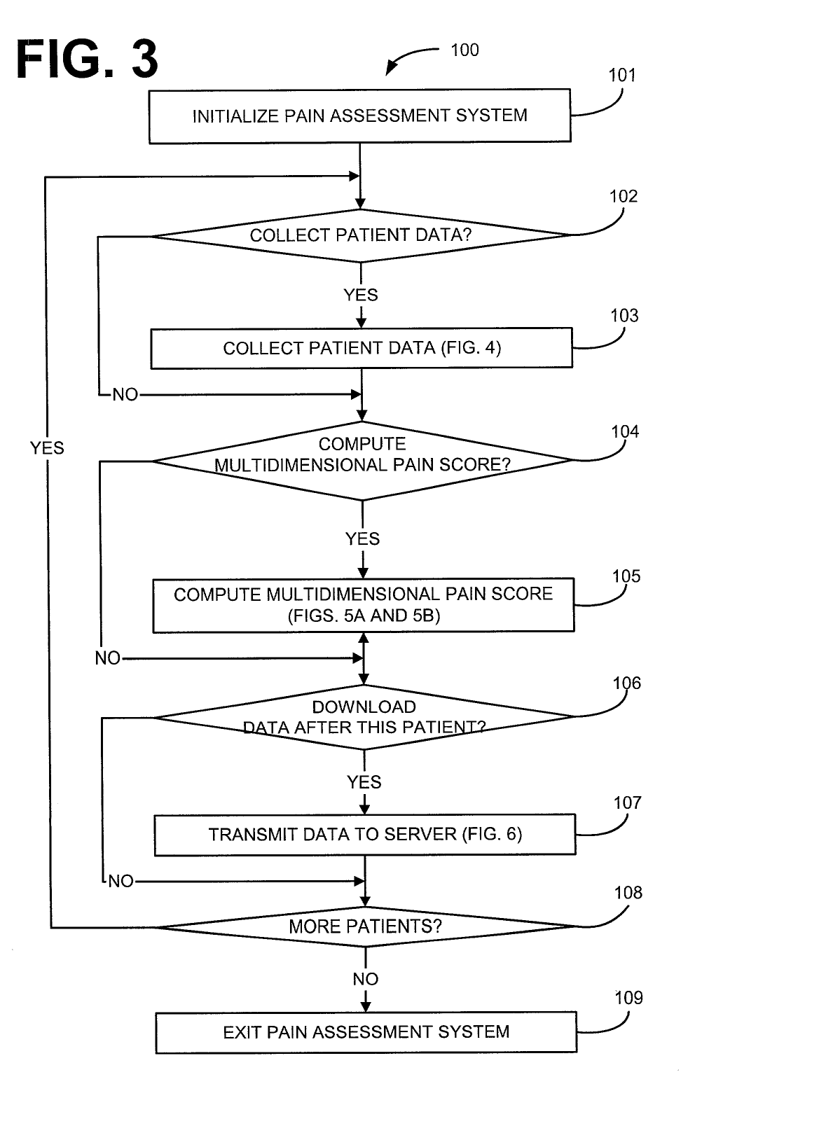

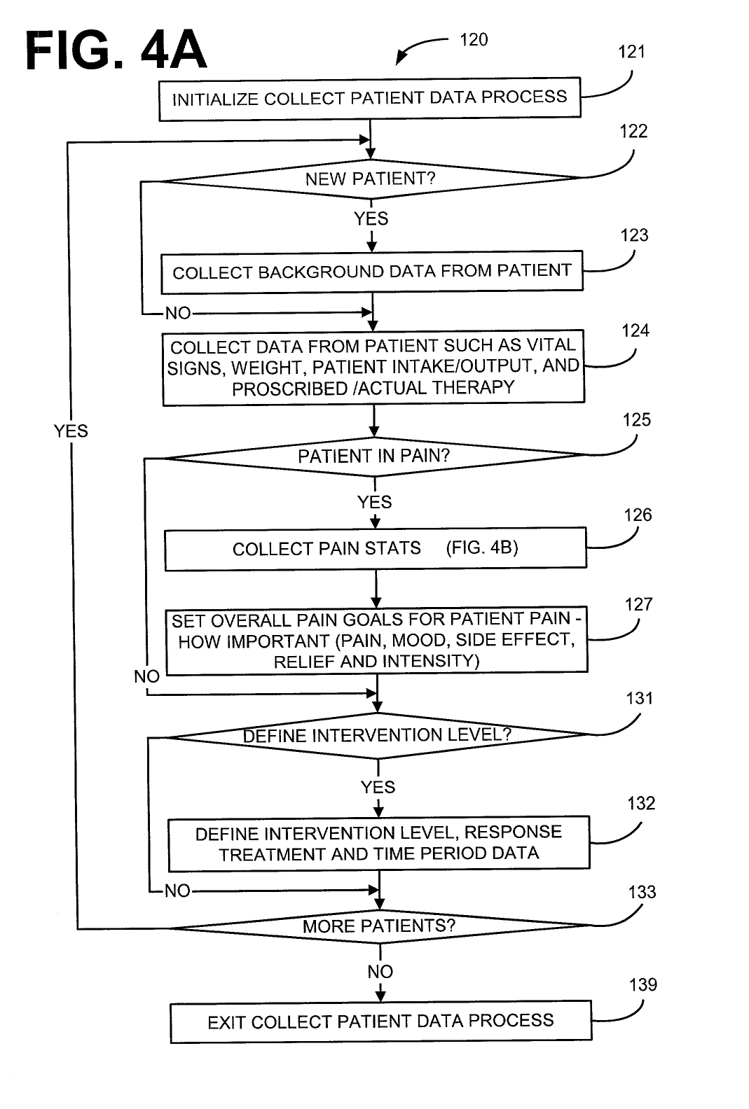

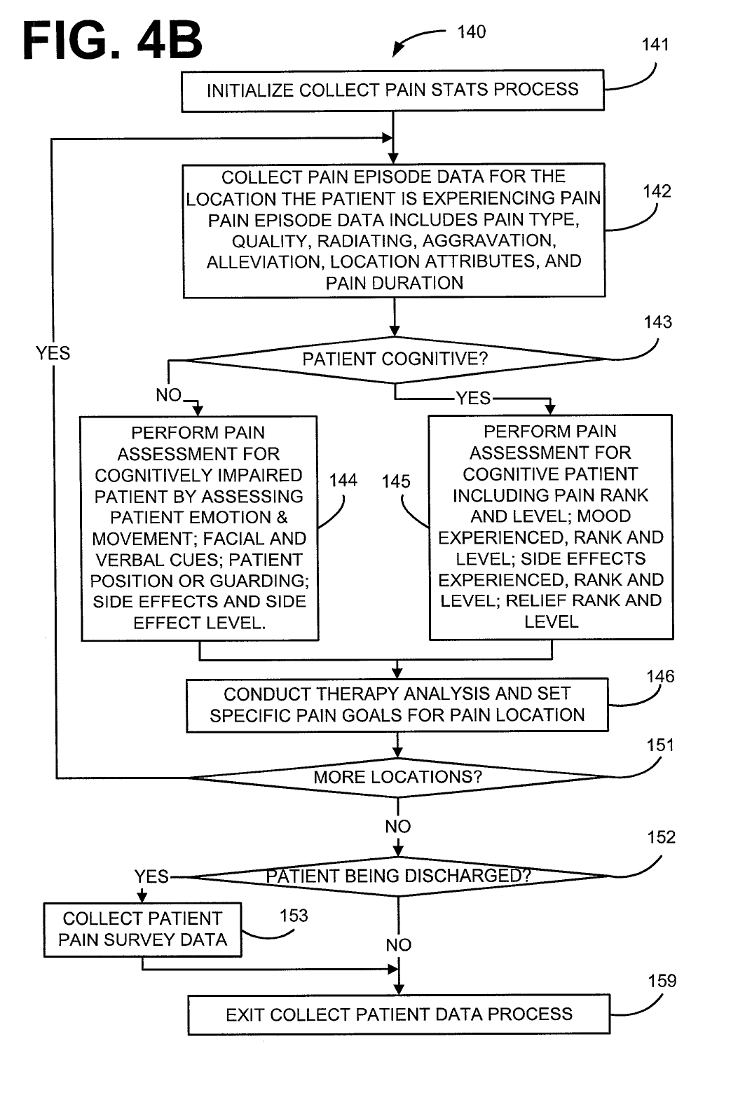

FIG. 3 is a flow chart illustrating the functionality of the pain assessment system 100 for computer system 11-14, 19, 21 or 22, shown in FIG. 2. First, the pain assessment system 100 is initialized at step 101. At step 102, the pain assessment system 100 determines whether a collection of patient data is to occur. If it is determined at step 102 that collection of patient data is not to occur, the pain assessment system 100 then proceeds to step 104. However, if it is determined at step 102 that the collection of patient data is to occur, the pain assessment system 100 then performs the collect patient data process at step 103. The collect patient data process is herein defined in further detail with regard to FIG. 4.

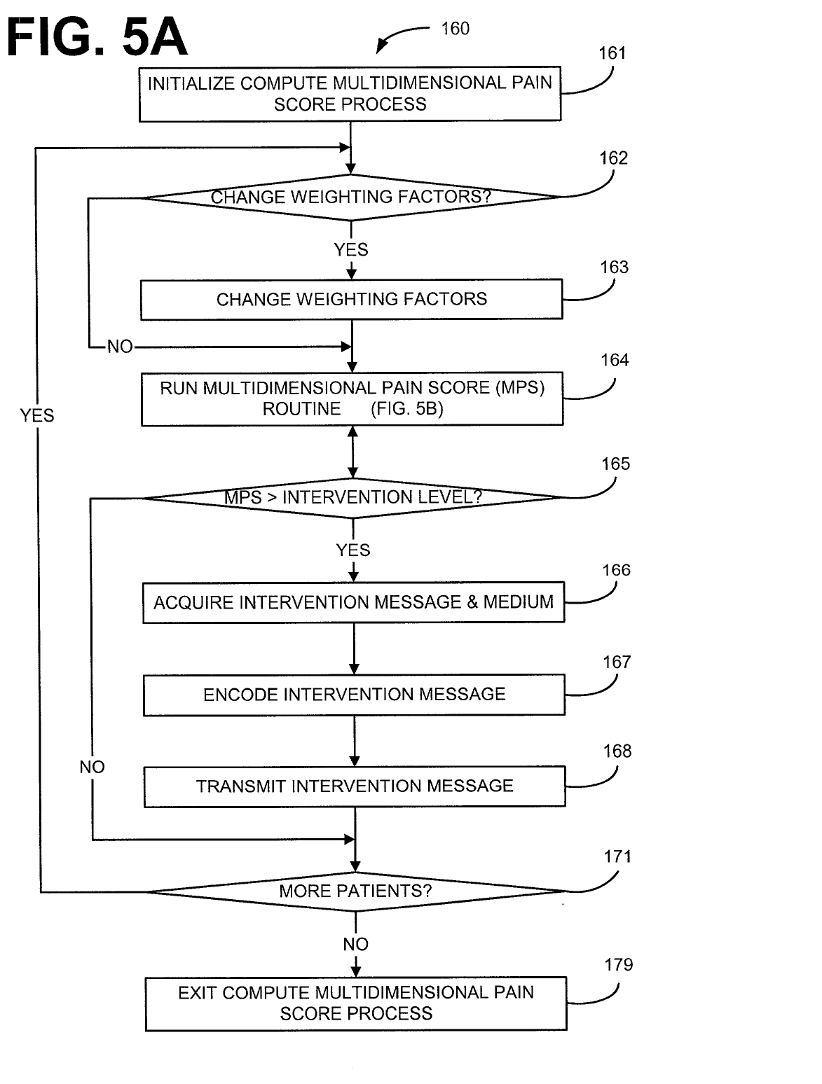

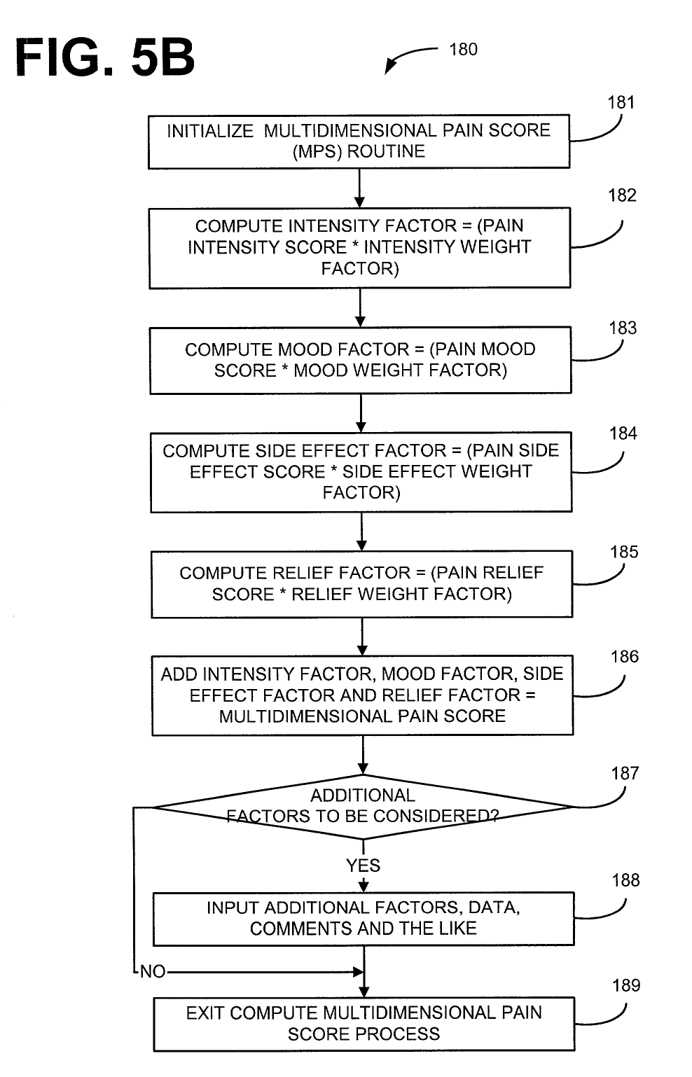

At step 104, the pain assessment system 100 then determines whether the computation of the multidimensional pain score is to occur. If it is determined at step 104 that the computation of the multidimensional pain score is not to occur, the pain assessment system 100 then proceeds to step 106. However, if it is determined at step 104 that the computation of the multidimensional pain score is to occur, the pain assessment system 100 then computes the multidimensional pain score at step 105. The computation of the multidimensional pain score is herein defined in further detail with regard to FIGS. 5A and 5B.

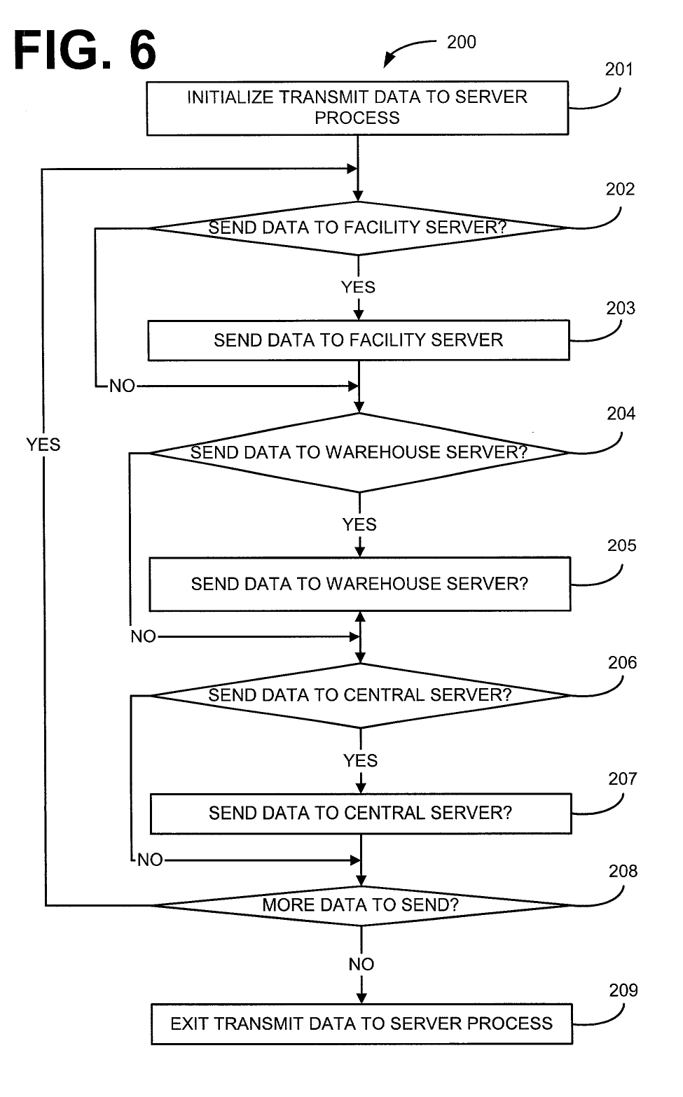

The pain assessment system 100 then determines, at step 106, whether it is to download patient data after the current patient. If it is determined at step 106 that the downloading of data after the current patient is not to occur, the pain assessment system 100 then skips to step 108. However, if it is determined at step 106 that the downloading of data after the current patient is to occur, the pain assessment system 100 then transmits the data to a server at step 107. The transmit data to server process is herein defined in further detail with regard to FIG. 6.

At step 108, the pain assessment system 100 then determines whether there are more patients to be processed. If it is determined at step 108 that there are more patients to be processed, the pain assessment system 100 then returns to repeat steps 102 through 108. If it is determined at step 108 that more patients are not to be processed, the pain assessment system then exits at step 109.

Illustrated in FIG. 4A is an example of the flow chart illustrating the collected data process 120 within the pain assessment system 100 as shown in FIGS. 2 and 3. First, the collect patient data process 120 is initialized at step 121. Next, at step 122, the collect patient data process 120 determines whether the patient for the data to be collected is a new patient. If it is determined at step 122 that the patient for data to be collected is not a new patient, the collect patient data process 120 then proceeds to step 124. If, however, it is determined at step 122 that the current patient for data to be collected is a new patient, the collect data patient process 120 then collects the background data from the patient at step 123.

At step 124, the collect patient data process 120 then allows the caregiver to collect data from the patient. The data collected from the patient includes, but is not limited to, vital signs, temperature, pulse, respiration, glucose level, hemoglobin level, blood pressure, pulse oximetry, weight, and patient intake/output type, description and amount at step 124. At step 125, the collect patient data process 120 then determines whether the patient is in pain. If it is determined at step 125 that the patient is not in pain, the collect patient data process then skips to step 131.

However, if it is determined at step 125 that the patient is in pain, the collect patient data process 120 then enables the caregiver to collect pain statistics by performing the collect pain statistics process at step 126. The collect pain statistics process is herein defined further with regard to FIG. 4B.

At step 127, the collect patient data process 120 then allows the caregiver and patient to set the overall pain goal data for the patient. These pain goals include how important the following factors are to the patient. The factors ranked in importance to the patient include, but are not limited to the location of pain, the amount of pain, how important the pain factor is, the patient's mood, the side effects of any pain treatment and/or the relief sought by the patient. The thresholds include, but are not limited to, the intensity of the pain, the patient's mood, the side effects of any pain treatment and/or the relief received from any pain treatment.

At step 131, the collect patient data process 120 determines if the caregiver or patient desires to define the intervention levels for the patient's pain. The intervention level defines the condition in which the pain assessment system 100 will notify the physician or caregiver or other agent that intervention is necessary for the treatment of the patient's pain. If it is determined at step 131 that the definition of an intervention level is not to occur, the collect patient data process 120 then skips to step 133. If it is determined at step 131 that the definition of intervention levels is to occur, the collect patient data process 120 then allows the caregiver or patient to define the intervention levels for patient pain to cause the physician or caregiver to be notified. Also included in this definition is the response treatment and time period data for the intervention to occur.

At step 133, the collect patient data process 120 then determines whether more patient data is to be collected. If it is determined at step 133 that there are more patients for data to be collected, the collect patient data process 120 then returns to repeat steps 122 through 133. If it is determined at step 133 that more patient data is not to be collected, the collect data patient process 120 then exits at step 139.

Illustrated in FIG. 4B is an example of a flow chart illustrating the collect pain statistics process 140 for the collect patient data process 120 in the pain assessment system 100 as shown in FIGS. 2, 3 and 4A. These pain statistics include, but are not limited to, data in regard to pain intensity, location, type, radiation, mood, treatment and treatment, side effects; and data in regard to vital signs, and the like.

First, the collect pain stats process 140 is initialized at step 141. At step 142, the collect pain stats process 140 collects the pain episode data for the location the patient is experiencing pain. Pain episode data includes, but is not limited to, pain location, pain type, pain quality, whether the pain is a radiating pain or a pinpoint pain, aggravation of the pain, alleviation of the pain, pain location attributes, and the pain duration.

At step 143, the collect pain stats process 140 then determines whether the patient is cognitive. If it is determined that the patient is not cognitive, then the pain collect stats process 140 performs the pain assessment for cognitively impaired patients, at step 144. The pain assessment for cognitively impaired patients is performed by assessing patient emotion and movement, patient facial and verbal cues, patient position or the parts of the body the patient guards, side effects and side effect levels. After performing the cognitively impaired patients pain assessment, the collect pain stats process 140 then proceeds to step 146. However, if it is determined at step 143 that the patient is cognitive, then the collect pain stats process 140 performs a pain assessment for the cognitive patient, at step 145. The pain assessment for cognitive patients includes assessment of pain rank and pain level, the mood experienced, mood rank and mood level, side effects experienced, rank of the side effects, and the side effect level, the relief rank and the relief level. All of these could be ascertained by presenting target questions to a cognitive patient.

At step 146, the collect pain stats process 140 then conducts therapy analysis and sets specific pain goals for the pain location. The therapy analysis includes, but is not limited to, the description of the therapy, units of measure of progress, frequency of the therapy, administration of the therapy, dose of any treatment, style of any therapy, and route of any therapy. The collect pain stats process 140 also enables the user to set specific pain goals for the specified pain location by defining and ranking the importance and impact of the pain location on the pain recovery.

At step 151, the collect pain stats process 140 determines whether there are more locations for pain assessment data to be collected. If it is determined at step 151 that there are more pain locations for the collection of pain episode data to be performed, the collect pain stats process 140 returns to repeat steps 142 through 151. However, if it is determined at step 151 that there are no more pain locations to collect pain episode data for, then the collect pain stats process 140 determines whether the patient is being discharged at step 152. If it is determined that the patient is not being discharged, then the collect pain stats process 140 proceeds to exit at step 159.

However, if it is determined at step 152 that the patient is being discharged, the collect pain stats process 140 then collects patient pain survey data at step 153. The patient pain survey data includes, but is not limited to, data collected regarding the patient's satisfaction with the stats belief of the patient's pain level, the level of education the patient received about pain, and the treatments and relief options for pain, as well as how satisfied the patient is with the stats timeliness and response to patient's pain needs, satisfaction with patient's overall pain treatment, how satisfied patient was that pain was accurately and adequately measured, and whether the measures to treat the patient's pain met the expectations of the patient. After completing the collect patient pain survey data, the collect pain stats process 140 then exits at step 159.

Illustrated in FIG. 5A is an example of a flow chart illustrating the compute multidimensional pain score process 160 for the pain assessment system 100 as shown in FIGS. 2 and 3. First, the compute multidimensional pain score process 160 is initialized at step 161. Next, at step 162, the compute multidimensional pain score process 160 determines whether the caregiver and/or patient wish to change the weighting factors of the pain variables used to compute the multidimensional pain score. If the caregiver and/or patient do not wish to change the weighting factors, the compute multidimensional pain score process 160 then proceeds to step 164.

However, if the caregiver and/or patient wish to change the weighting factors for the pain variables, the compute multidimensional pain score process 160 then allows the changing of the weighting factors at step 163. Step 163 allows the caregiver or patient to manually control the weighting of the four or more pain variables used to compute the multidimensional pain score. This changing of the weighting factors step 163 allows the caregiver or user to value each of the pain variables by relative values to 100 percent. This changing of the weighting factors allows the caregiver or patient to equally wait all the pain variables or to create some combination of weighting of the pain variables in order of priority to caregiver or patient.

At step 164, the compute multidimensional pain score process 160 then runs the multidimensional pain score routine. The multidimensional pain score routine is herein defined further with regard to FIG. 5B. After acquiring the multidimensional pain score (MPS), the compute multidimensional pain score process 160 then determines whether the MPS is greater than the intervention level at step 165. If it is determined at step 165 that the MPS is not greater than the intervention level, the compute multidimensional pain score process then skips to step 171.

However, if it is determined at step 165 that the MPS is greater than the intervention level, the compute multidimensional pain score process 160 then acquires the appropriate intervention message medium at step 166. The intervention message medium is the medium in which the patient or caregiver desire to be notified that the multidimensional pain score exceeds the intervention level. The intervention message medium includes, but is not limited, to facsimile, pager, e-mail, voice mail, telephone, cell phone, personal digital assistant or the like.

After acquiring the intervention message and medium at step 166, the compute multidimensional pain score process 160 then encodes the intervention message at step 167. Next, at step 168, the compute multidimensional pain score process 160 then transmits the intervention message to the physician, caregiver or other agent to be notified that the multidimensional pain score has exceeded an intervention level at step 168.

At step 171, the compute multidimensional pain score process 160 then determines whether more multidimensional pain scores are to be computed for other patients. If it is determined at step 171 that there are more patients to compute multidimensional pain scores for, the compute multidimensional pain score process 160 then returns to repeat steps 162 through 171. However, if it is determined at step 171 that there are no more patients for the multidimensional pain score to be computed, the compute multidimensional pain score process 160 then exits at step 179.

Illustrated in FIG. 5B is an example of a flow chart illustrating the multidimensional pain score routine 180. First, the multidimensional pain score routine 180 is initialized at step 181. Next, at step 182, the intensity factor is computed. The pain intensity factor is equal to the pain intensity score, which is computed from the pain statistics collected at step 160 (FIG. 4B), and the intensity weight factor. The intensity weight factor can be a default value established by the pain assessment system 100 or the weighting factor assigned at step 162 (FIG. 5A).

Next, at step 183, the mood factor is computed. The mood factor is equal to the pain mood score that is computed from the data collected at step 160 (FIG. 4B) and the mood weight factor. The mood weight factor can be a default value established by the pain assessment system 100 or the weighting factor assigned at step 162 (FIG. 5A).

At step 184, the multidimensional pain score routine 180 then computes the side effect factor that is equal to the pain side effect score computed utilizing the data collected from the patient at step 160 (FIG. 4B) and the side effect weight factor. As discussed above, the side effect weight factor can be a default value that is established by the pain assessment system 100, or input by the caregiver or patient at step 162 (FIG. 5A).

Next, the multidimensional pain score routine 180 computes the relief factor at step 185. The relief factor comprises the pain relief score computed from the data collected at step 124 (FIG. 4) and the pain relief weight factor established by the pain assessment system 100 or established by the caregiver or patient at step 162 (FIG. 5A).

At step 186, the multidimensional pain score routine 180 then adds the intensity factor, mood factor, side effect factor and pain factor to establish a multidimensional pain score. Next, at step 187, the multidimensional pain score routine 180 then determines whether additional factors are to be considered in the multidimensional pain score. If it is determined at step 187 that there are no additional factors to consider, the multidimensional pain score routine 180 then proceeds to exit at step 189. If it is determined at step 187 that additional factors are to be considered, the multidimensional pain score routine 180 then allows the caregiver or patient to input additional factors, data, comments and the like to be included in the multidimensional pain score at step 188. The multidimensional pain score routine 180 then exits at step 189.

Illustrated in FIG. 6 is an example of a flow chart illustrating the transmit data to server process 200 for the pain assessment system 100 of the present invention illustrated in FIGS. 2 and 3. First, the transmit data to server process 200 is initialized at step 201. Next, at step 202, the transmit data to server process 200 determines whether data is to be sent to the facility server. If it is determined at step 202 that the data is not to be sent to the facility server, the transmit data to server process 200 then proceeds to step 204. However, if it is determined at step 202 that data is to be sent to the facility server, the transmit data to server process 200 then sends the data to the facility server at step 203.

At step 204, the transmit data to server process 200 then determines whether the data is to be sent to the warehouse server. If it is determined that the data is not to be sent to the warehouse server, the transmit data to server process 200 then skips to step 206. If it is determined at step 204 that data is to be sent to the warehouse server, the transmit data to server process 200 then sends the patient data to the warehouse server at step 205.

At step 206, the transmit data to server process 200 then determines whether data is to be sent to the central server. If it is determined at step 206 that data is not to be sent to the central server, the transmit data to server process 200 then skips to step 208. However, if it is determined at step 206 that data is to be sent to the central server, the transmit data to server process 200 then sends the data to the central server at step 207.

At step 208, the transmit data to server process 200 then determines whether there is more data to be sent. If it is determined at step 208 that there is more data to be sent, the transmit data to server process 200 then returns to repeat steps 202 through 208. However, if it is determined at step 208 that there is no more data to be sent to a server, the transmit data to server process 200 then exits at step 209.

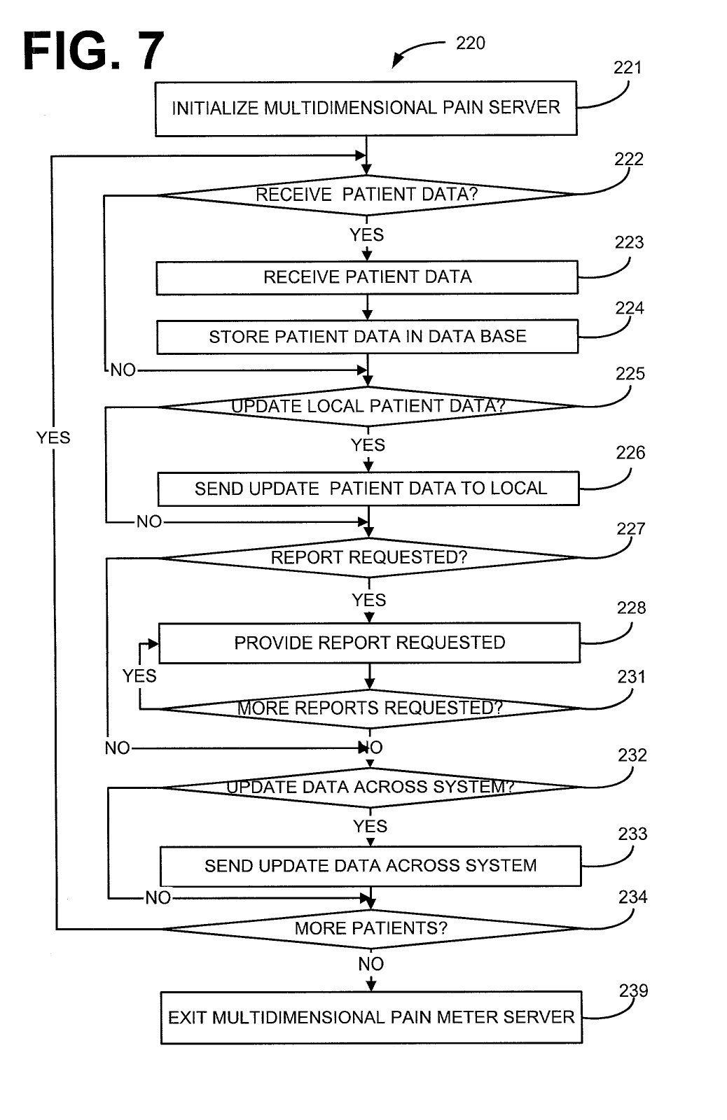

Illustrated in FIG. 7 is a flow chart illustrating the multidimensional pain server 220. First, the multidimensional pain server 220 is initialized at step 223. Next, there is a determination of whether the multidimensional pain server 220 is to receive patient data at step 222. If it is determined at step 222 that the server processing system is not to receive patient data, the multidimensional pain meter server processing system 220 then proceeds to step 225. If it is determined at step 222 that the multidimensional pain server 220 is to receive patient data, the multidimensional pain server 220 receives patient data at step 223. At step 224, the multidimensional pain server 220 then stores the patient data in the database.

At step 225, the multidimensional pain server 220 then determines whether it is to update local patient data. If it is determined at step 225 that update of local patient data is not to occur, the multidimensional pain server 220 then proceeds to step 227. If it is determined at step 225 that the multidimensional pain server 220 is to update local patient data, the multidimensional pain server 220 sends the updated patient data to the local system at step 226.

At step 227, the multidimensional pain server 220 then determines whether a report output is requested. If it is determined at step 227 that a report is not requested, the multidimensional pain server 220 proceeds to step 232. If it is determined at step 227 that a report is requested, the multidimensional pain server 220 then provides the report requested at step 228. At step 231, it is determined whether there are more reports requested. If it is determined at step 231 that there are more reports requested, the multidimensional pain server 220 then returns to repeat step 228 and 231.

If it is determined at step 231 that there are no more reports requested, the multidimensional pain server 220 then determines whether it is to update data across the system at step 232. If it is determined at step 232 that the data is not to be updated across the system, the multidimensional pain server 220 then proceeds to step 234. If it is determined at step 232 that data is to be updated across the system, the multidimensional pain server then sends the updated data across the system at step 233.

At step 234, the multidimensional pain meter server 220 then determines whether there are more patients to be processed at step 234. If it is determined at step 234 that there are more patients to be processed, the multidimensional pain server 220 then returns to repeat steps 222 through 234. If it is determined at step 234 that there are no more patients to be processed, the multidimensional pain server then exits at step 239.

The foregoing description has been presented for purposes of illustration and description. It is not intended to be exhaustive or to limit the invention to the precise forms disclosed. Obvious modifications or variations are possible in light of the above teachings. The embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

What is claimed is:

1. A method for quantifying a pain condition of a patient, the method comprising the steps of:
acquiring pain episode data for the patient;
performing pain assessment on the patient; and
generating a multidimensional pain score that quantifies a pain condition for the patient.

2. The method of claim 1, wherein the step of the performing pain assessment further comprises the step of:
determining if the patient is cognitively impaired.

3. The method of claim 2, wherein the step of the performing pain assessment further comprises the step of:
acquiring a plurality of implicit pain factors if the patient is cognitively impaired, wherein the implicit pain factors are selected from the group consisting of patient emotion, patient movement, patient facial cues, patient verbal cues, patient position, patient guarding areas, observed therapy side effects and observed therapy side effect level.

4. The method of claim 2, wherein the step of the performing pain assessment further comprises the step of:
acquiring a plurality of explicit pain factors if the patient is not cognitively impaired, wherein the explicit pain factors are selected from the group consisting of pain intensity, patient mood, therapy side effects and pain relief.

5. The method of claim 1, further comprising the step of:
generating an intervention required notice when the multidimensional pain score exceeds a predetermined intervention level.

6. The method of claim 1, further comprising the step of:
generating a factor score for each of a plurality of pain factors; and
generating an intervention required notice when the factor score exceeds a predetermined intervention level.

7. A system for quantifying a pain condition of a patient, comprising:
a means for acquiring a pain episode data for the patient;
a means for performing pain assessment for the patient; and
a means for generating a multidimensional pain score that quantifies a pain condition for the patient.

8. The system of claim 7, wherein the means for performing pain assessment further comprises:
a means for acquiring a plurality of implicit pain factors if the patient is cognitively impaired, wherein the implicit pain factors are selected from the group consisting of patient emotion, patient movement, patient facial cues, patient verbal cues, patient position, patient guarding areas, observed therapy side effects and observed therapy side effect level.

9. The system of claim 7, wherein the means for performing pain assessment further comprises:
a means for acquiring a plurality of explicit pain factors if the patient is not cognitively impaired, wherein the explicit pain factors are selected from the group consisting of pain intensity, patient mood, therapy side effects and pain relief.

10. The system of claim 7, further comprising:
a means for generating an intervention required notice when the multidimensional pain score exceeds a predetermined intervention level.

11. The system of claim 7, further comprising:
a means for generating a factor score for each of a plurality of pain factors; and
a means for generating an intervention required notice when the factor score exceeds a predetermined intervention level.

12. A system that quantifies a pain condition of a patient, comprising:
a description input mechanism that prompts the collection of patient pain episode data;
a pain assessment mechanism that assesses the pain episode data for the patient; and
a pain score generation mechanism that generates a multidimensional pain score from the pain episode data to quantify a pain condition for the patient.

13. The system of claim 12, wherein the pain assessment mechanism further comprises:
a cognitively impaired pain factors mechanism that acquires a plurality of implicit pain factors if the patient is cognitively impaired, wherein the implicit pain factors are selected from the group consisting of patient emotion, patient movement, patient facial cues, patient verbal cues, patient position, patient guarding areas, observed therapy side effects and observed therapy side effect level.

14. The system of claim 12, wherein the pain assessment mechanism further comprises:
a noncognitively impaired pain factors mechanism that acquires a plurality of explicit pain factors if the patient is not cognitively impaired, wherein the explicit pain factors are selected from the group consisting of pain intensity, patient mood, therapy side effects and pain relief.

15. The system of claim 12, wherein the pain assessment mechanism further comprises:
a factor scoring mechanism that generates a factor score for each of a plurality of pain factors.

16. The system of claim 15, wherein the pain assessment mechanism further comprises:
a notice generating mechanism that generates an intervention required notice when the factor score exceeds a predetermined intervention level.

17. The system of claim 12, further comprising:
a notice generating mechanism that generates an intervention required notice when the multidimensional pain score exceeds a predetermined intervention level.

18. The system of claim 12, wherein the system is a hand-held device.

19. A computer readable medium having a program for generating a multidimensional pain score to quantify a pain condition of a patient, comprising:
a logic that prompts the collection of patient pain episode data;
a logic that assesses the pain episode data for the patient; and
a logic that generates a multidimensional pain score from the pain episode data to quantify a pain condition for the patient.

20. The computer readable medium of claim 19, wherein the logic that assesses the pain episode data further comprises:
a first logic, responsive to the logic that assesses the pain episode data, that acquires a plurality of implicit pain factors if the patient is cognitively impaired, wherein the implicit pain factors are selected from the group consisting of patient emotion, patient movement, patient facial cues, patient verbal cues, patient position, patient guarding areas, observed therapy side effects and observed therapy side effect level.

21. The computer readable medium of claim 19, wherein the logic that assesses the pain episode data further comprises:
a second logic, responsive to the logic that assesses the pain episode data, that acquires a plurality of explicit pain factors if the patient is not cognitively impaired, wherein the explicit pain factors are selected from the group consisting of pain intensity, patient mood, therapy side effects and pain relief.

22. The computer readable medium of claim 19, wherein the logic that generates a multidimensional pain score further comprises:
a third logic, responsive to the logic that assesses the pain episode data, that generates a factor score for each of a plurality of pain factors.

23. The computer readable medium of claim 22, further comprising:
a logic, responsive to the third logic, for generating an intervention required notice when the factor score exceeds a predetermined intervention level.

24. The computer readable medium of claim 19, further comprising:
a logic, responsive to the logic that generates a multidimensional pain score, for generating an intervention required notice when the multidimensional pain score exceeds a predetermined intervention level.
